(19) United States
(12) Patent Application Publication
(10) Pub. No.: US 2017/0186444 A1
(43) Pub. Date: Jun. 29, 2017

(54) Tracking user feeling about exercise

(71) Applicant: Intel Corporation, Santa Clara, CA (US)

(72) Inventor: Mei Lu, Portland, OR (US)

(73) Assignee: Intel Corporation, Santa Clara, CA (US)

(21) Appl. No.: 14/998,259

(22) Filed: Dec. 24, 2015

(51) Int. Cl. G10L 25/63; G10L 15/08

(52) U.S. Cl. CPC G10L 25/63; G10L 15/08

(57) ABSTRACT

One embodiment provides an apparatus. The apparatus includes user subjective data (USD) logic to track user subjective data during exercise via user speech. The apparatus further includes a microphone to capture the user speech, the user speech comprising the user subjective data.

### FIELD

The present disclosure relates to tracking user feeling, in particular to, tracking user feeling about exercise.

### BACKGROUND

Users, e.g., athletes, may engage in athletic activities (i.e., workouts) that challenge physiological systems. For example, interval training is configured to facilitate conditioning. Interval training may be utilized for sports including, but not limited to, running, biking (i.e., bicycling), skiing, rowing, swimming and/or a combination, e.g., triathlon activities (running, swimming, cycling). Interval training includes a plurality of sequential intervals with each interval having an associated exercise intensity. For example, a first interval may be a high intensity exercise period and a second interval may be a recovery (i.e., less intense) period. An associated exercise program may include a plurality of sequences where each sequence contains the first interval followed by the second interval.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 illustrates a functional block diagram of a user feeling tracking system consistent with several embodiments of the present disclosure;

FIG. 2 is a flowchart of user feeling tracking operations according to various embodiments of the present disclosure;

FIG. 3 is a flowchart of user feeling display operations according to various embodiments of the present disclosure;

FIG. 4 is one example table illustrating objective data annotated with user perceived effort; and

FIG. 5 is one example plot illustrating objective data annotated with user perceived effort and user narrative.

Although the following Detailed Description will proceed with reference being made to illustrative embodiments, many alternatives, modifications, and variations thereof will be apparent to those skilled in the art.

### DETAILED DESCRIPTION

A user may monitor exertion and/or recovery during the training. For example, a sensing device may be configured to capture objective data. Objective data may include, but is not limited to, one or more of heart rate, speed, cadence and/or power output. The user may then later utilize the captured objective data to evaluate the workout. While the objective data is useful, such data does not provide the user an indication of how the user was feeling during the exercise.

Generally, this disclosure relates to tracking user feeling about exercise. An apparatus, method and/or system are configured to track user subjective data during exercise via user speech. The subjective data may include, but is not limited to, a perceived effort numeric indicator, a perceived effort descriptor and/or a user narrative related to how the user is feeling. For example, the user speech may include a numeric indicator that corresponds to the user's perceived effort. In another example, the user speech may include a narrative that includes the user's description of his or her feelings. The user subjective data may be captured in response to a trigger from the user. The trigger may include, but is not limited to, a voice command, a gesture, etc. The apparatus, method and/or system may be further configured to correlate the captured subjective data to an associated exercise regime, to an interval boundary, to a distance and/or to a time indicator, e.g., a time stamp. In some embodiments, the apparatus, method and/or system may be further configured to capture a snapshot of objective data in response to the trigger.

The apparatus, method and/or system are further configured to process the captured speech, translate the captured speech into text and store the text to a data store for later display to the user. The numeric indicator may be associated with a predefined perceived effort descriptor. The user narrative is relatively less constrained. In other words, the perceived effort descriptor may be limited to a number of predefined phrases corresponding to perceived effort. On the other hand, the user narrative related to user feeling is generally unconstrained, with the content of the narrative determined by the user. In some embodiments, the text may be displayed to the user as an annotation to displayed objective data.

Advantageously, capturing user speech facilitates acquiring user subjective data during the exercise. In other words, capturing the user speech avoids diverting the user's attention to a user interface that may require the user to read displayed text and then select a displayed option. The user narrative may provide a relatively more accurate and relatively more detailed account of the user's feeling about exercise since the user narrative is not limited to a finite number of predefined possibilities. Acquiring the user subjective data “in the moment” is configured to provide a relatively more accurate account of user feeling compared to acquiring user subjective data at or after completion of the exercise. User subjective data may also be acquired at the completion of an exercise regime to provide a general overview of the user feeling about the exercise. The combination of objective data and user subjective data may then facilitate a relatively more complete post-workout analysis by the user.

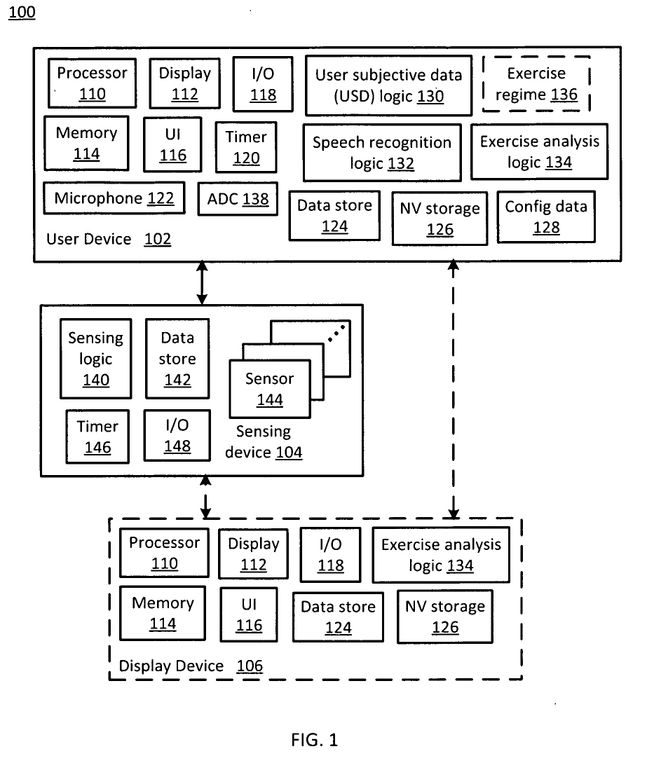

FIG. 1 illustrates a functional block diagram of a user feeling tracking system 100 consistent with several embodiments of the present disclosure. The user feeling tracking system 100 may include a user device 102 and a sensing device 104. In an embodiment, system 100 may further include a display device 106. In another embodiment, system 100 may not include the display device 106 and user device 102 may then perform display operations, as described herein. User device 102 and display device 106 (if present) may include, but are not limited to, a mobile telephone including, but not limited to a smart phone (e.g., iPhone®, Android®-based phone, Blackberry®, Symbian®-based phone, Palm®-based phone, etc.); a wearable device (e.g., wearable computer, “smart” watches, smart glasses, smart clothing, etc.) and/or system; a portable computing system (e.g., a laptop computer, a tablet computer (e.g., iPad®, GalaxyTab® and the like), an ultraportable computer, an ultramobile computer, a netbook computer and/or a subnotebook computer; etc. Display device 106 may further include a desk top computer, a tower computer, etc. In other words, display device 106 may have a form factor that is larger than that of user device 102 thus facilitating display of user subjective and/or objective data. Sensing device 104 is configured to capture user objective data. Sensing device 104 may include, but is not limited to, a smart phone, a wearable device and/or a sensor system that includes one or more sensor(s), e.g., sensor 144.

User device 102 includes a processor 110, a display 112, a memory 114, a user interface (UI) 116, an input/output module (I/O) 118, a timer 120, a microphone 122, an analog to digital converter (ADC) 138, a data store 124 and nonvolatile (NV) storage 126. User device 102 may further include configuration data 128, user subjective data (USD) logic 130, a speech recognition logic 132 and exercise analysis logic 134. In some embodiments, user device 102 may include an exercise regime 136. Sensing device 104 includes sensing logic 140, a data store 142, one or more sensor(s), e.g., sensor 144 and a timer 146. In an embodiment, sensing device 104 may be included in user device 102. In another embodiment, sensing device 104 may be coupled to user device 102, wired and/or wirelessly.

Processor 110 is configured to perform operations of user device 102. Display 112 is configured to display user subjective data, including a perceived effort numeric indicator, a perceived effort descriptor and/or a user feeling narrative, in text format, to a user. Display 112 may be further configured to display objective data to the user. The objective data may be in tabular and/or graphical format and may be annotated with user subjective data text, as described herein. Display 112 may be a touch sensitive display configured to detect gestures, e.g., a tap, two taps, as described herein. User interface 116 may include a touch sensitive display and/or one or more momentary switches (e.g., button(s)) configured to capture user inputs. Thus, in some embodiments, display 112 may correspond to user interface 116.

Memory 114 and/or NV storage 126 are configured to store data store 124, configuration data 128 and exercise regime 136. I/O 118, 148 are configured to provide communication capability between user device 102 and sensing device 104. I/O 118 may be further configured to provide communication capability between user device 102 and another user device (not shown) and/or display device 106 (if any). For example, I/O 118, 148 may be configured to communicate using one or more near field communication (NFC) protocol(s), as described herein. In another example, I/O 118 may be configured to communicate using one or more wired and/or wireless communication protocols, as described herein. For example, I/O 118, 148 may be configured to communicate using a Universal Serial Bus (USB) communication protocol, as described herein.

Timer 120 is configured to provide timing information to USD logic 130, exercise analysis logic 134 and/or exercise regime 136. Timer 146 is configured to provide timing information to sensing logic 140 and/or sensor 144. The timing information may include a time stamp. For example, timer 120 and/or 146 may correspond to a clock. In another example, timer 120 and/or 146 may include an oscillator with a known period. In some embodiments, timer 120 may be configured to synchronize with timer 146. The timing information, e.g., time stamp, may then be utilized by USD logic 130 to correlate user subjective data to user objective data, as described herein.

Microphone 122 is configured to capture user speech and to convert the captured speech into a corresponding electrical representation (i.e., speech signal). The user speech may include user subjective data. The speech signal may then be digitized by ADC 138, stored to data store 124 and retrieved by speech recognition logic 132 for analysis. For example, the speech recognition logic 132 may be configured to identify a numeric perceived effort indicator. In another example, the speech recognition logic 132 may be configured to determine (i.e., recognize) a user feeling narrative included in the captured speech and to convert the user feeling narrative to corresponding text for storage and later retrieval. Data store 124 is configured to store the digitized user speech for retrieval by speech recognition logic 132. Data store 124 is further configured to store text representations of captured user speech, as described herein. The captured user speech may include user subjective data. The user subjective data may include a numeric perceived effort indicator, a perceived effort descriptor and/or a user feeling narrative.

Display device 106 (if present), similar to user device 102, may include a processor 110, a display 112, memory 114, UI 116 and I/O 118. Such elements have similar function for display device 106 as for user device 102. Display device 106 may further include data store 124, NV storage 126 and exercise analysis logic 134. Data store 124 and/or NV storage 126 are configured to store user subjective data (and corresponding text) and user objective data, as described herein. Exercise analysis logic 134 is configured to display the user objective data annotated with the user subjective data, as described herein.

Configuration data 128 may be stored to data store 124 and/or NV storage 126. Configuration data 128 includes user-customizable, i.e., selectable, parameters related to the operation of USD logic 130, exercise analysis logic 134 and/or exercise regime 136. Configuration data 128 may include one or more of a subjective data recording indicator, a trigger indicator, an interval boundary indicator and/or a numeric indicator range. The subjective data recording indicator is configured to indicate whether a numeric perceived effort indicator, a user feeling narrative or both should be captured and stored. The user may thus select the user subjective data to be captured and stored for later display. The trigger indicator is configured to indicate whether user subjective data should be captured during an interval (e.g., a manual trigger), at an interval boundary and/or upon completion of a selected workout regime.

The interval boundary indicator is configured to indicate whether an interval boundary should be detected automatically or manually. Automatically detecting the interval boundary corresponds to detecting the interval boundary based, at least in part, on user objective data, e.g., a change in a captured value of user objective data and/or based, at least in part, on characteristics of the selected exercise regime. For example, a user's exercise intensity may increase, e.g., peak, just prior to an interval boundary and may decrease immediately following the interval boundary (for a boundary between a first, relatively high intensity interval followed by a second, relatively less intense interval). The change in exercise intensity may be detected, for example, by a change in cadence, a change in speed, etc. In another example, an interval boundary may be detected, e.g., identified, based, at least in part, on information related to exercise regime 136. In other words, the exercise regime 136 may include time duration and/or distance parameters associated with each of a plurality of defined intervals. These parameters may then by utilized by USD logic 130 (along with objective data, i.e., time and/or distance) to automatically detect an interval boundary. Thus, automatically detecting an interval boundary may occur without user input.

A manual trigger corresponds to a user input including, but not limited to, a voice command, a gesture and/or a press of a button. Manually detecting the interval boundary corresponds to detecting the interval boundary based, at least in part, on a user input configured to indicate occurrence of an interval boundary. The user input may include, but is not limited to, a voice command, a gesture and/or a press of a button (i.e., momentary switch). For example, USD logic 130 may be configured to acquire text output from speech recognition logic 132, identify the voice command and initiate capture of user subjective data, as described herein. In some embodiments, the user may be provided a prompt related to exercise regime 136 indicating that an interval boundary is imminent. In other words, exercise regime 136 may be configured to provide prompts to the user related to interval boundaries. The prompts may then be utilized by the user to support manual detection of the interval boundary. Thus, capture of user subjective data may be initiated during an interval and/or at an interval boundary.

Configuration data 128 may further include an indicator related to range of values for perceived effort numeric indicators. For example, the range may be selected from the group comprising 1-5, 1-7, 1-10, 7-20. In another example, the range may be user-defined and stored to configuration data 128. Thus, a user may select a range of values for the perceived effort indicator.

Sensing logic 140 is configured to manage operation of sensing device 104. Sensing logic 140 may include a microcontroller, an application-specific integrated circuit (ASIC), programmable circuitry, etc. Data store 142 is configured to store user objective data. Sensing logic 140 is configured to detect and/or capture user objective data from each of the sensors, e.g., sensor 144, and to store the user objective data to data store 142. Thus, data store 142 may store sensor data from each of a plurality of sensors that may then be acquired by, e.g., USD logic 130 and/or exercise analysis logic 134.

Sensor(s), e.g., sensor 144, may include, but are not limited to, one or more of a pedometer, an odometer, a speedometer, an accelerometer, a gyroscope, a heart rate monitor, a foot pod, a cadence sensor, a power output meter, an altimeter, a global positioning system (GPS) receiver and/or a combination thereof. Individual sensor(s) may be wearable (e.g., heart rate monitor, foot pod) or mounted on the user's exercise equipment (e.g., bicycle-mounted power meter, bicycle mounted cadence sensor). A pedometer is configured to count a number of steps by a user during walking and/or running. Cadence is related to speed. For example, in biking, cadence corresponds to a number of revolutions (i.e., cycles) of bicycle pedals in a time interval. In another example, in running, cadence corresponds to a number of cycles of two steps in a time interval, e.g., one minute. Power output is a performance measure related to biking and corresponds to an amount of power generated by the biking activity.

Exercise regime 136 corresponds to a predefined exercise program, i.e., a workout. User device 102 may be configured to store one or more exercise regime(s), e.g., exercise regime 136. Each exercise regime may be user selectable and may include one or more intervals (i.e., laps). Each exercise regime may be associated with one or more physical activities and may further be configured to provide a respective target intensity over one or more intervals separated by interval boundaries.

In operation, USD logic 130 may be configured to detect initiation of physical activity, e.g., exercise. For example, physical activity may be initiated following selection of an exercise regime, e.g., exercise regime 136. Initiation of physical activity may be detected based, at least in part, on the sensor data captured from sensing device 104. For example, motion of user device 102 and/or sensing device 104 may be detected. In this example, sensor 144 may correspond to an accelerometer. In another example, initiation of physical activity may be detected based, at least in part, on a user input. The user input may include, but is not limited to, a voice command captured by microphone 122, a gesture captured by display 112 and/or user interface 116 and/or selection of exercise regime 136. The captured voice command may be recognized by speech recognition logic 132 and interpreted by USD logic 130. The gesture may be recognized by display 112, user interface 116 and/or USD logic 130.

In response to detecting initiation of physical activity, USD logic 130 is configured to monitor display 112, user interface 116 and/or microphone 122. The monitoring is configured to detect a trigger from a user associated with capturing user subjective data. For example, microphone 122 may capture user speech that corresponds to a voice command configured to trigger capturing user subjective data. The voice command captured by microphone 122 may be digitized by ADC 138, stored to data store 124 by, e.g., USD logic 130, and retrieved by speech recognition logic 132. Speech recognition logic 132 may then perform speech recognition operations. For example, the voice command may include “start”, “start subjective data capture”, “initiate capture”, and/or one or more spoken words configured to initiate subjective data capture. In another example, display 112 and/or user interface 116 may capture a user gesture. User gestures may include, but are not limited to, a tap, a double tap, etc. In another example, user interface 116 may capture a button press.

In some situations, exercise regime 136 may include a plurality of training intervals. Each training interval may be characterized by a level of intensity of the physical activity included within the training interval. For example, a first training interval may include intense physical activity and the first training interval may be followed by a second training interval that includes a relatively less intense physical activity. Continuing with this example, each training interval may have an associated time duration and/or an associated interval distance. The first training interval may end and the second training interval may begin at an interval boundary. In some embodiments, capture of user subjective data may be initiated based, at least in part, on detection of a training interval boundary. For example, USD logic 130 may be configured to detect a training interval boundary based, at least in part, on sensor data acquired from sensing device 104. The training interval boundary may be detected based, at least in part, on a change in physical activity, a time duration, a distance and/or a user input. Whether a training interval boundary initiates user subjective data acquisition may be based, at least in part, on user selection of the trigger indicator prior to initiation of the associated exercise regime, as described herein. The user selection related to the trigger indicator may be stored to data store 124 in configuration data 128.

If a data capture trigger is detected, USD logic 130 is configured to monitor microphone 122 to detect user speech that includes user subjective data. Microphone 122 is configured to capture the user speech and convert the user speech to a time varying electrical signal (“speech signal”) that represents (i.e., corresponds to) the user speech. The speech signal may then be digitized by ADC 138, stored to data store 124 and retrieved by speech recognition logic 132. Speech recognition logic 132 is configured to retrieve the digitized speech and to process the digitized speech. Speech recognition logic 132 is further configured to determine whether the digitized speech corresponds to a perceived intensity numeric indicator and/or a user feeling narrative. If the digitized speech corresponds to a numeric indicator, speech recognition logic 132 is configured to identify the number and to provide a digital representation, e.g., binary number, to USD logic 130. If the digitized speech corresponds to a user feeling narrative, speech recognition logic 132 is configured to convert the narrative into corresponding text, e.g., an ASCII (American Standard Code for Information Interchange) representation, and to provide the ASCII representation of the user feeling narrative to USD logic 130.

USD logic 130 may then be configured to store the digital representation and/or the ASCII representation of the captured (converted and digitized) speech to data store 124. In some embodiments, the digital representation may be associated with a numeric indicator and/or a perceived effort descriptor. The numeric indicator may be a number in a predefined range of perceived effort numeric indicators. The predefined range may be, for example, 1-5, 1-7, 1-10 or 7-20. In another example, the perceived effort descriptor may be a text string that corresponds to the perceived effort numeric indicator. Continuing with this example, the text string may include, e.g., “very easy”, “relatively easy”, “moderate”, “relatively difficult”, “very difficult”, etc. The perceived effort descriptor is configured to provide a qualitative description associated with each corresponding numeric indicator.

At or near the time that the user speech is detected, USD logic 130 may be further configured to capture a time indicator and/or a distance indicator. The time indicator may correspond to a timestamp and/or an interval boundary identifier. In one example, the time indicator may be captured from timer 120. In another example, the time indicator may be captured from timer 146. For time indicators that correspond to timestamps, time may be measured from initiation of an associated exercise regime and/or may correspond to an absolute time, e.g., time of day. In some embodiments, timer 120 and timer 146 may be synchronized so that both timers 120, 146 provide a same time indicator. The distance indicator may be captured from sensor 144. For example, sensor 144 may correspond to a GPS receiver, a pedometer or an odometer (e.g., on a bicycle). The distance indicator may thus correspond to a distance traveled since initiation of the exercise and/or to a physical location.

USD logic 130 may then be configured to associate the captured time indicator and/or distance indicator with the captured speech and to store the time and/or distance indicator to data store 124. In other words, USD logic 130 may be configured to associate the captured time and/or distance indicator with the user subjective data stored to data store 124. The stored user subjective data may thus include digital representations of a perceived effort numeric indicator, a perceived effort descriptor and/or a user feeling narrative. Associating a time value or a distance travelled with the stored user subjective data is configured to facilitate displaying user subjective data correlated with user objective data, to the user.

In some embodiments, USD logic 130 may be configured to acquire objective data from sensing device 104 at or near the time that the user speech is captured. This acquired objective data is configured to provide a snapshot of user objective data associated with the corresponding user subjective data. This snapshot of objective data is in addition to the objective data capture being performed by sensing device 104 during the physical activity. The sensing device 104 may be configured to capture user objective data periodically over the duration of the physical activity. The snapshot represents the objective data at one point in time related to capture of corresponding user subjective data. USD logic 130 may be further configured store the captured snapshot of objective data to data store 124, associated with a time indicator and/or a distance.

USD logic 130 may be configured to repeat monitoring for a trigger and, if the trigger is detected, capturing and storing the user subjective data, the associated time and/or distance indicator and possibly the snapshot of objective data over the duration of the user physical activity. USD logic 130 is further configured to monitor user physical activity to detect an end of user physical activity. For example, the end of user physical activity may correspond to a time interval boundary, a timestamp, a distance, a user command and/or completion of the exercise regime. The user command may be a gesture and/or a speech command. If the end of user activity is detected, USD logic 130 may be configured to acquire end of activity user subjective data. Similar to acquisition of user subjective data during physical activity, speech recognition logic 132 is configured to convert the captured user speech to a digital representation and/or an ASCII representation. USD logic 130 and/or speech recognition logic 132 may then store the user subjective data to data store 124.

Capture of user subjective data and/or acquisition of user objective data may be repeated for one or more exercise regimes. The user subjective data and/or user objective data may be stored to data store 124 and/or data store 142. At the completion of a specific exercise regime, the user subjective data and/or user objective data may be stored to nonvolatile storage 126. The user subjective data and/or user objective data may be associated with an exercise regime indicator when stored to nonvolatile storage 126. The data may be later retrieved by, for example, exercise analysis logic 134, for display to, and analysis by, the user.

USD logic 130 may be configured to receive a time and/or distance indicator that corresponds to a time and/or distance during an exercise regime where the user wishes to retrieve a perceived effort indicator and/or the user feeling narrative describing how the user was feeling at that point in time. For example, the time and/or distance indicator may be received from exercise analysis logic 134. Exercise analysis logic 134 may be further configured to retrieve a continuous representation of captured objective data from data store 142 and/or a snapshot of captured objective data from data store 124. In some embodiments, USD logic 130 is configured to determine whether data store 124 and/or data store 142 contains captured user subjective data associated with the received time and/or distance indicator. If neither data store 124, 142 contains captured subjective data, the user may be notified that there is no data to display.

If there is stored subjective data, USD logic 130 is configured to retrieve the stored subjective data from data store 124. The stored subjective data may include text a perceived effort descriptor that corresponds to a stored perceived effort numeric indicator and/or a user feeling narrative, as described herein. USD logic 130 is configured to provide the retrieved user subjective data to exercise analysis logic 134 for display to the user using, e.g., display 112. Exercise analysis logic 134 may be configured to retrieve stored objective data and/or annotate retrieved stored objective data for display to the user.

Thus, user feeling about exercise may be tracked via user speech. Capturing user speech during physical activity avoids diverting the user's attention to a display. User subjective data may be captured during user physical activity in response to a trigger, e.g., initiated by the user. The captured user subjective data may be associated with a time and/or distance indicator so that the user subjective data may be correlated with user objective data. The user subjective data may include a numeric indicator that corresponds to perceived effort, a perceived effort descriptor and/or a user feeling narrative describing the user's feeling about the corresponding user objective data. The user narrative may provide a relatively more accurate and relatively more detailed account of the user's feeling about exercise since the user narrative is not limited to a finite number of predefined possibilities.

Thus, the user may be provided, i.e., displayed, user subjective data, captured in real time during the physical activity. Reliance on the user's ability (or lack thereof) to remember his or her feeling during the physical activity at some time after completion of the physical activity may be avoided. Providing user subjective data correlated with user objective data is configured to enhance the user's training.

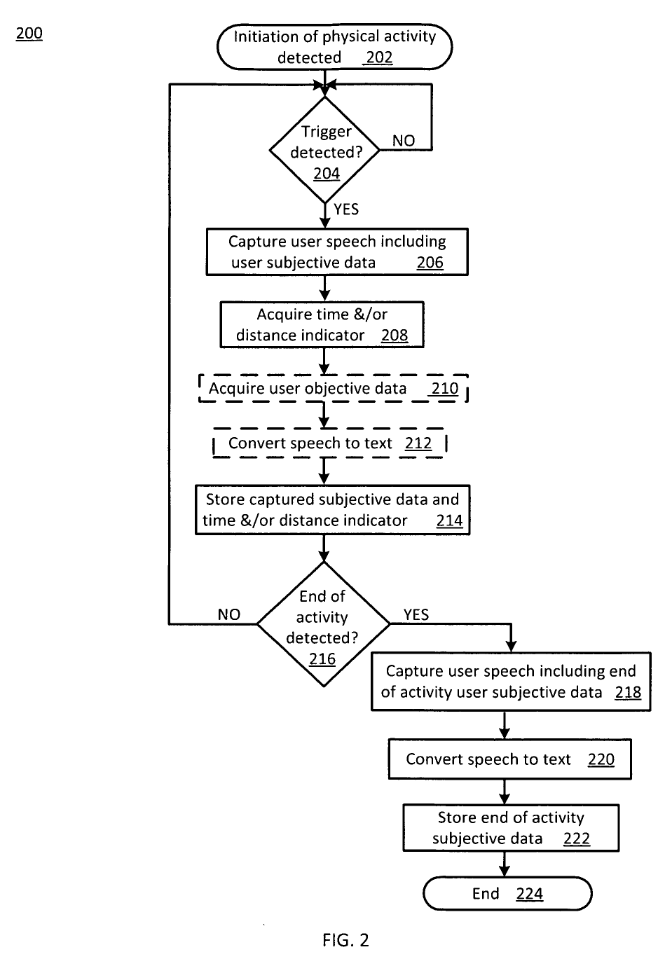

FIG. 2 is a flowchart of user feeling tracking operations according to various embodiments of the present disclosure. In particular, the flowchart 200 illustrates capturing user subjective data during physical activity. The operations may be performed, for example, by user device 102 and USD logic 130 of FIG. 1.

Operations of this embodiment may begin with detection of initiation of physical activity at operation 202. Whether a trigger has been detected may be determined at operation 204. If a trigger has not been detected, program flow may return to operation 204. If a trigger has been detected, user speech including user subjective data may be captured at operation 206. A time and/or distance indicator may be acquired at operation 208. In some embodiments, user objective data (i.e., a snapshot of user objective data) may be acquired at operation 210. In some embodiments, captured user speech may be converted to text at operation 212. For example, user narrative may be converted to text. In another example, a numeric indicator related to the user perceived exercise intensity may be converted to a perceived intensity descriptor. The captured subjective data and time and/or distance indicator may be stored at operation 214.

Whether an end of activity has been detected may be determined at operation 216. If the end of activity has not been detected, program flow may proceed to operation 204. If the end of activity is detected, user speech including end of activity user subjective data may be captured at operation 218. Captured speech may be converted to text at operation 220. For example, the captured speech may correspond to a user narrative related to the user feeling about an entire exercise regime. End of activity subjective data may be stored at operation 222. Program flow may then end at operation 224.

Thus, user subjective data may be captured during physical activity and may be correlated, using a time and/or distance indicator, with objective data associated with the physical activity. The subjective data and objective data may later be displayed to the user for review and analysis.

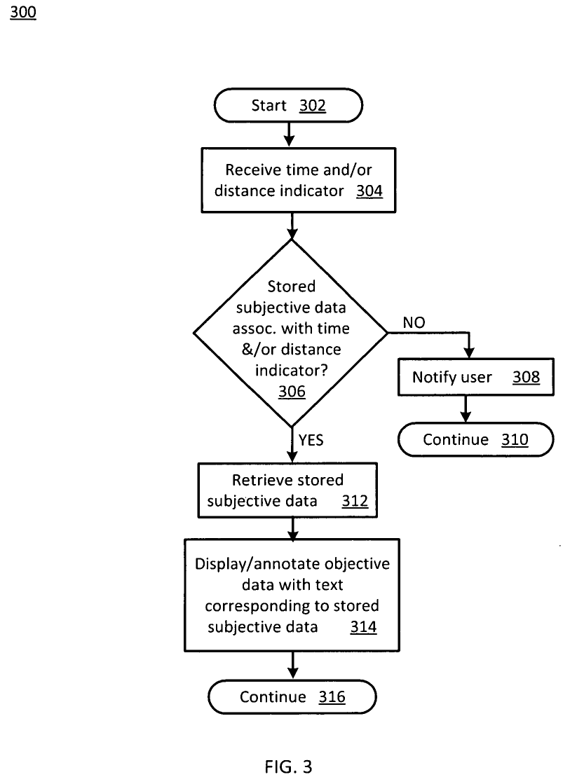

FIG. 3 is a flowchart of user feeling display operations, according to various embodiments of the present disclosure. In particular, the flowchart 300 illustrates retrieving and displaying stored subjective data. The operations may be performed, for example, by user device 102 and/or display device 106, e.g., exercise analysis logic 134, of FIG. 1.

Operations of this embodiment may begin with start 302. A time and/or distance indicator may be received at operation 304. For example, the time and/or distance indicator may be associated with objective data being displayed to the user by, e.g., exercise analysis logic 134. Whether there is stored subjective data associated with the time and/or distance indicator may be determined at operation 306. If there is no stored subjective data associated with the time and/or distance indicator, the user may be notified at operation 308. Program flow may then continue at operation 310. If there is stored subjective data associated with the time and/or distance indicator, the stored subjective data may be retrieved at operation 312. Objective data may be annotated with text corresponding to the retrieved stored subjective data and displayed at operation 314. Program flow may then continue at operation 316. Thus, user subjective data may be captured via speech during physical activity and user objective data may be annotated with the captured subjective data for display to the user after the physical activity.

While the flowcharts of FIGS. 2 and 3 illustrate operations according various embodiments, it is to be understood that not all of the operations depicted in FIGS. 2 and 3 are necessary for other embodiments. In addition, it is fully contemplated herein that in other embodiments of the present disclosure, the operations depicted in FIGS. 2 and/or 3 and/or other operations described herein may be combined in a manner not specifically shown in any of the drawings, and such embodiments may include less or more operations than are illustrated in FIGS. 2 and 3. Thus, claims directed to features and/or operations that are not exactly shown in one drawing are deemed within the scope and content of the present disclosure.

Thus, user subjective data may be tracked via user speech during exercise. The user subjective data may include a numeric indicator of perceived intensity, a perceived effort descriptor and/or a user feeling narrative. The captured speech may be converted to a digital and/or textual representation and stored. The captured user subjective data may then be correlated with an associated exercise regime, an interval boundary and/or a time and/or distance indicator. User objective data may then be annotated with text corresponding to correlated user subjective data and displayed to the user. The display of objective data annotated with subjective data is configured to facilitate improving performance.

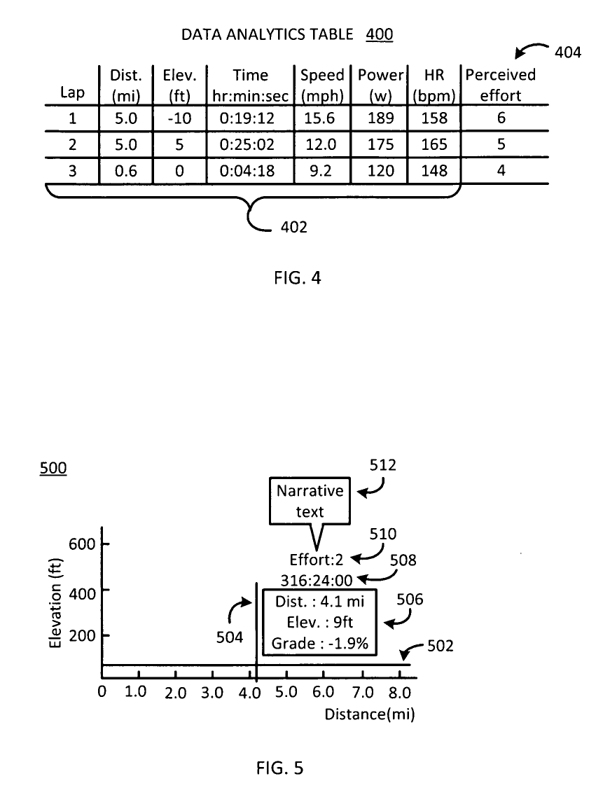

FIG. 4 is one example table 400 illustrating objective data 402 annotated with user perceived effort 404. Table 400 corresponds to a data analytics table for a biking exercise regime. The exercise regime included three intervals (i.e., laps). The objective data 402 includes distance in miles, elevation change in feet, time in hours, minutes and seconds, speed in miles per hour (mph), power output in watts and heart rate in beats per minute, for each lap. Each lap is annotated with a numeric perceived effort indicator. Thus, data analytics table 400 illustrates user objective data annotated with corresponding user subjective data.

FIG. 5 is one example plot 500 illustrating objective data annotated with user perceived effort 510 and user narrative 512. Plot 500 illustrates variation in elevation 502 versus distance for a biking exercise regime. The elevation is in units of feet and the distance is in miles. The grade, i.e., elevation variation, is in percent. Plot 500 further illustrates annotation with both objective data and subjective data. In this example, the annotation and distance marker 504 correspond to a distance, e.g., 4.1 miles. Annotated objective data 506, includes distance travelled, elevation and grade. Annotated objective data further includes a time indicator 508.

Continuing with this example 500, user subjective data includes both a numeric indicator corresponding to perceived effort 510 and user feeling narrative text 512. The subjective data 510, 512 annotates the objective data 506, 508 at the distance marker 504. Thus, user objective data, in graphical and/or textual format may be annotated with user subjective data and displayed.

As used in any embodiment herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The logic may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

The foregoing provides example system architectures and methodologies, however, modifications to the present disclosure are possible. The processor may include one or more processor cores and may be configured to execute system software. System software may include, for example, an operating system. Device memory may include I/O memory buffers configured to store one or more data packets that are to be transmitted by, or received by, a network interface.

The operating system (OS) may be configured to manage system resources and control tasks that are run on, e.g., user device 102. For example, the OS may be implemented using Microsoft® Windows®, HP-UX®, Linux®, or UNIX®, although other operating systems may be used. In another example, the OS may be implemented using Android™, iOS, Windows Phone® or BlackBerry®. In some embodiments, the OS may be replaced by a virtual machine monitor (or hypervisor) which may provide a layer of abstraction for underlying hardware to various operating systems (virtual machines) running on one or more processing units. The operating system and/or virtual machine may implement one or more protocol stacks. A protocol stack may execute one or more programs to process packets. An example of a protocol stack is a TCP/IP (Transport Control Protocol/Internet Protocol) protocol stack comprising one or more programs for handling (e.g., processing or generating) packets to transmit and/or receive over a network.

User device 102, sensing device 104 and/or display device 106 may comply and/or be compatible with one or more communication specifications, standards and/or protocols. The communications protocols may include but are not limited to wired communications protocols, such as USB (Universal Serial Bus), wireless communications protocols, such as NFC, RFID, Wi-Fi, Bluetooth, 3G, 4G and/or other communication protocols.

For example, user device 102, sensing device 104 and/or display device 106 may comply or be compatible with Universal Serial Bus Specification, Revision 2.0, published by the Universal Serial Bus organization, Apr. 27, 2000, and/or later versions of this specification, for example, Universal Serial Bus 3.0 Specification (including errata and ECNs through May 1, 2011) and/or Universal Serial Bus Specification, Revision 3.1, published Jul. 26, 2013.

For example, user device 102, sensing device 104 and/or display device 106 may comply and/or be compatible with Bluetooth® Core Specification, version 4.2, published by Bluetooth® SIG (Special Interest Group), Kirkland, Wash., December 2014, and/or later and/or related versions of this standard, e.g., Bluetooth® Low Energy (BLE), Bluetooth® Smart and/or Bluetooth® Core Specification, version 4.0, published June 2010.

The Wi-Fi protocol may comply or be compatible with the 802.11 standards published by the Institute of Electrical and Electronics Engineers (IEEE), titled “IEEE 802.11-2007 Standard, IEEE Standard for Information Technology-Telecommunications and Information Exchange Between Systems-Local and Metropolitan Area Networks-Specific Requirements—Part 11: Wireless LAN Medium Access Control (MAC) and Physical Layer (PHY) Specifications” published, Mar. 8, 2007, and/or later versions of this standard.

The NFC and/or RFID communication signal and/or protocol may comply or be compatible with one or more NFC and/or RFID standards published by the International Standards Organization (ISO) and/or the International Electrotechnical Commission (IEC), including ISO/IEC 14443, titled: Identification cards—Contactless integrated circuit cards—Proximity cards, published in 2008; ISO/IEC 15693: Identification cards—Contactless integrated circuit cards—Vicinity cards, published in 2006, titled: ISO/IEC 18000, titled: Information technology—Radio frequency identification for item management, published in 2008; and/or ISO/IEC 18092, titled: Information technology—Telecommunications and information exchange between systems—Near Field Communication—Interface and Protocol, published in 2004; and/or later versions of these standards.

In another example, user device 102, sensing device 104 and/or display device 106 may comply and/or be compatible with IEEE (Institute of Electrical and Electronics Engineers) 802.15.4-2006 standard titled: IEEE Standard for Information technology—Telecommunications and information exchange between systems—Local and metropolitan area networks—Specific requirements Part 15.4: Wireless Medium Access Control (MAC) and Physical Layer (PHY) Specifications for Low Rate Wireless Personal Area Networks (LR-WPANS), published in 2006 and/or later and/or related versions of this standard.

In another example, user device 102, sensing device 104 and/or display device 106 may comply and/or be compatible with a ZigBee specification and/or standard, published and/or released by the ZigBee Alliance, Inc., including, but not limited to, ZigBee 3.0, draft released November 2014, ZigBee RF4CE, ZigBee IP, and/or ZigBee PRO published in 2012, and/or later and/or related versions of these standards.

In another example, user device 102, sensing device 104 and/or display device 106 may comply and/or be compatible with IEEE Std 802.11™-2012 standard titled: IEEE Standard for Information technology—Telecommunications and information exchange between systems—Local and metropolitan area networks—Specific requirements Part 11: Wireless LAN Medium Access Control (MAC) and Physical Layer (PHY) Specifications, published in March 2012 and/or earlier and/or later and/or related versions of this standard, including, for example, IEEE Std 802.11ac™-2013, titled IEEE Standard for Information technology-Telecommunications and information exchange between systems, Local and metropolitan area networks-Specific requirements, Part 11: Wireless LAN Medium Access Control (MAC) and Physical Layer (PHY) Specifications; Amendment 4: Enhancements for Very High Throughput for Operation in Bands below 6 GHz, published by the IEEE, December 2013.

User device 102, sensing device 104 and/or display device 106 may comply and/or be compatible with one or more third generation (3G) telecommunication standards, recommendations and/or protocols that may comply and/or be compatible with International Telecommunication Union (ITU) Improved Mobile Telephone Communications (IMT)-2000 family of standards released beginning in 1992, and/or later and/or related releases of these standards. For example, user device 102, sensing device 104 and/or display device 106 may comply and/or be compatible with one or more CDMA (Code Division Multiple Access) 2000 standard(s) and/or later and/or related versions of these standards including, for example, CDMA2000 1×RTT, 1× Advanced and/or CDMA2000 1×EV-DO (Evolution-Data Optimized): Release 0, Revision A, Revision B, Ultra Mobile Broadband (UMB). In another example, user device 102, sensing device 104 and/or display device 106 may comply and/or be compatible with UMTS (Universal Mobile Telecommunication System) standard and/or later and/or related versions of these standards.

User device 102, sensing device 104 and/or display device 106 may comply and/or be compatible with one or more fourth generation (4G) telecommunication standards, recommendations and/or protocols that may comply and/or be compatible with ITU IMT-Advanced family of standards released beginning in March 2008, and/or later and/or related releases of these standards. For example, user device 102, sensing device 104 and/or display device 106 may comply and/or be compatible with IEEE standard: IEEE Std 802.16™-2012, title: IEEE Standard for Air Interface for Broadband Wireless Access Systems, released August 2012, and/or related and/or later versions of this standard. In another example, user device 102, sensing device 104 and/or display device 106 may comply and/or be compatible with Long Term Evolution (LTE), Release 8, released March 2011, by the Third Generation Partnership Project (3GPP) and/or later and/or related versions of these standards, specifications and releases, for example, LTE-Advanced, Release 10, released April 2011.

Memory 114 may include one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory may include other and/or later-developed types of computer-readable memory.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

In some embodiments, a hardware description language (HDL) may be used to specify circuit and/or logic implementation(s) for the various logic and/or circuitry described herein. For example, in one embodiment the hardware description language may comply or be compatible with a very high speed integrated circuits (VHSIC) hardware description language (VHDL) that may enable semiconductor fabrication of one or more circuits and/or logic described herein. The VHDL may comply or be compatible with IEEE Standard 1076-1987, IEEE Standard 1076.2, IEEE1076.1, IEEE Draft 3.0 of VHDL-2006, IEEE Draft 4.0 of VHDL-2008 and/or other versions of the IEEE VHDL standards and/or other hardware description standards.

Thus, an apparatus, method and/or system are configured to track user subjective data during exercise via user speech. The subjective data may include, but is not limited to, a perceived effort descriptor and/or a user narrative related to how the user is feeling. The captured subjective data may be correlated to an associated exercise regime, to an interval boundary and/or to a time and/or distance indicator. In some embodiments, the apparatus, method and/or system may be further configured to capture objective data in response to the trigger.

The captured speech may be processed, translated into text and stored to a data store for later display to the user. The numeric indicator may be associated with a predefined perceived effort descriptor. The captured narrative is relatively less constrained. In other words, the perceived effort descriptor may be limited to a range of numeric values while the narrative related to user feeling may be generally unconstrained. In some embodiments, the text may be displayed to the user as an annotation to displayed objective data.

Capturing user speech may facilitate capturing user subjective data during exercise by avoiding diverting the user's attention to a user interface that may require the user to read displayed text and then select an option. Capturing the user subjective data “in the moment” is configured to provide a relatively more accurate account of user feeling compared to capturing user subjective data at or after completion of the exercise. User subjective data may also be captured at the completion of an exercise regime to provide a general overview of the user feeling about the exercise.

### EXAMPLES

Examples of the present disclosure include subject material such as a method, means for performing acts of the method, a device, or of an apparatus or system related to tracking user feeling about exercise, as discussed below.

### Example 1

According to this example, there is provided an apparatus. The apparatus includes user subjective data (USD) logic to track user subjective data during exercise via user speech. The apparatus further includes a microphone to capture the user speech, the user speech including the user subjective data.

### Example 2

This example includes the elements of example 1, wherein the user subjective data includes one or more of a perceived effort numeric indicator, a perceived effort descriptor and a user feeling narrative.

### Example 3

This example includes the elements of example 1, wherein the USD logic is further to correlate the captured user subjective data to an associated exercise regime.

### Example 4

This example includes the elements of example 1, further including a speech recognition logic to convert the captured user speech to text.

### Example 5

This example includes the elements according to any one of examples 1 to 4, further including exercise analysis logic to display the user subjective data annotated to associated objective data.

### Example 6

This example includes the elements according to any one of examples 1 to 4, wherein the USD logic is further to capture user objective data.

### Example 7

This example includes the elements according to any one of examples 1 to 4, wherein the user speech further includes end of activity user subjective data.

### Example 8

This example includes the elements according to any one of examples 1 to 4, wherein the user subjective data is captured in response to a trigger from the user.

### Example 9

This example includes the elements of example 8, wherein the trigger is a voice command or a gesture.

### Example 10

This example includes the elements according to any one of examples 1 to 4, further including a data store to store configuration data, the configuration data including user selectable parameters related to operation of the USD logic.

### Example 11

This example includes the elements according to any one of examples 1 to 4, wherein the USD logic is to detect initiation of physical activity.

### Example 12

This example includes the elements according to any one of examples 1 to 4, wherein the user subjective data is captured in response to detecting a training interval boundary.

### Example 13

According to this example, there is provided a method. The method includes tracking, by user subjective data (USD) logic, user subjective data during exercise via user speech; and capturing, by a microphone, the user speech, the user speech including the user subjective data.

### Example 14

This example includes the elements of example 13, wherein the user subjective data includes one or more of a perceived effort numeric indicator, a perceived effort descriptor and a user feeling narrative.

### Example 15

This example includes the elements of example 13, further including correlating, by the USD logic, the captured user subjective data to an associated exercise regime.

### Example 16

This example includes the elements of example 13, further including converting, by a speech recognition logic, the captured user speech to text.

### Example 17

This example includes the elements of example 13, further including displaying, by exercise analysis logic, the user subjective data annotated to associated objective data.

### Example 18

This example includes the elements of example 13, further including capturing, by the USD logic, user objective data.

### Example 19

This example includes the elements of example 13, wherein the user speech further includes end of activity user subjective data.

### Example 20

This example includes the elements of example 13, wherein the user subjective data is captured in response to a trigger from the user.

### Example 21

This example includes the elements of example 20, wherein the trigger is a voice command or a gesture.

### Example 22

This example includes the elements of example 13, further including storing, by a data store, configuration data, the configuration data including user selectable parameters related to operation of the USD logic.

### Example 23

This example includes the elements of example 13, further including detecting, by the USD logic, initiation of physical activity.

### Example 24

This example includes the elements of example 13, wherein the user subjective data is captured in response to detecting a training interval boundary.

### Example 25

According to this example, there is provided a system. The system includes a user device. The user device includes a processor; user subjective data (USD) logic to track user subjective data during exercise via user speech; and a microphone to capture the user speech, the user speech including the user subjective data.

### Example 26

This example includes the elements of example 25, wherein the user subjective data includes one or more of a perceived effort numeric indicator, a perceived effort descriptor and a user feeling narrative.

### Example 27

This example includes the elements of example 25, wherein the USD logic is further to correlate the captured user subjective data to an associated exercise regime.

### Example 28

This example includes the elements of example 25, wherein the user device further includes a speech recognition logic to convert the captured user speech to text.

### Example 29

This example includes the elements according to any one of examples 25 to 28, wherein the user device further includes exercise analysis logic to display the user subjective data annotated to associated objective data.

### Example 30

This example includes the elements according to any one of examples 25 to 28, wherein the USD logic is further to capture user objective data.

### Example 31

This example includes the elements according to any one of examples 25 to 28, wherein the user speech further includes end of activity user subjective data.

### Example 32

This example includes the elements according to any one of examples 25 to 28, wherein the user subjective data is captured in response to a trigger from the user.

### Example 33

This example includes the elements of example 32, wherein the trigger is a voice command or a gesture.

### Example 34

This example includes the elements according to any one of examples 25 to 28, further including a data store to store configuration data, the configuration data including user selectable parameters related to operation of the USD logic.

### Example 35

This example includes the elements according to any one of examples 25 to 28, wherein the USD logic is to detect initiation of physical activity.

### Example 36

This example includes the elements according to any one of examples 25 to 28, wherein the user subjective data is captured in response to detecting a training interval boundary.

### Example 37

According to this example, there is provided a computer readable storage device. The device has stored thereon instructions that when executed by one or more processors result in the following operations including tracking user subjective data during exercise via user speech; and capturing the user speech, the user speech including the user subjective data.

### Example 38

This example includes the elements of example 37, wherein the user subjective data includes one or more of a perceived effort numeric indicator, a perceived effort descriptor and a user feeling narrative.

### Example 39

This example includes the elements of example 37, wherein the instructions that when executed by one or more processors results in the following additional operations including correlating the captured user subjective data to an associated exercise regime.

### Example 40

This example includes the elements according to any one of examples 37 to 40, wherein the instructions that when executed by one or more processors results in the following additional operations including converting the captured user speech to text.

### Example 41

This example includes the elements according to any one of examples 37 to 40, wherein the instructions that when executed by one or more processors results in the following additional operations including displaying the user subjective data annotated to associated objective data.

### Example 42

This example includes the elements according to any one of examples 37 to 40, wherein the instructions that when executed by one or more processors results in the following additional operations including capturing user objective data.

### Example 43

This example includes the elements according to any one of examples 37 to 40, wherein the user speech further includes end of activity user subjective data.

### Example 44

According to this example, there is provided a system. The system includes at least one device arranged to perform the method of any one of claims 13 to 24.

### Example 45

According to this example, there is provided a device. The device includes means to perform the method of any one of claims 13 to 24.

### Example 46

According to this example, there is provided a computer readable storage device having stored thereon instructions that when executed by one or more processors result in the following operations including: the method according to any one of claims 13 through 24.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. An apparatus comprising:
user subjective data (USD) logic to track user subjective data during exercise via user speech; and
a microphone to capture the user speech, the user speech comprising the user subjective data.

2. The apparatus of claim 1, wherein the user subjective data comprises one or more of a perceived effort numeric indicator, a perceived effort descriptor and a user feeling narrative.

3. The apparatus of claim 1, wherein the USD logic is further to correlate the captured user subjective data to an associated exercise regime.

4. The apparatus of claim 1, further comprising a speech recognition logic to convert the captured user speech to text.

5. The apparatus of claim 1, further comprising exercise analysis logic to display the user subjective data annotated to associated objective data.

6. The apparatus of claim 1, wherein the USD logic is further to capture user objective data.

7. The apparatus of claim 1, wherein the user speech further comprises end of activity user subjective data.

8. A method comprising:
tracking, by user subjective data (USD) logic, user subjective data during exercise via user speech; and
capturing, by a microphone, the user speech, the user speech comprising the user subjective data.

9. The method of claim 8, wherein the user subjective data comprises one or more of a perceived effort numeric indicator, a perceived effort descriptor and a user feeling narrative.

10. The method of claim 8, further comprising correlating, by the USD logic, the captured user subjective data to an associated exercise regime.

11. The method of claim 8, further comprising converting, by a speech recognition logic, the captured user speech to text.

12. The method of claim 8, further comprising displaying, by exercise analysis logic, the user subjective data annotated to associated objective data.

13. The method of claim 8, further comprising capturing, by the USD logic, user objective data.

14. The method of claim 8, wherein the user speech further comprises end of activity user subjective data.

15. A computer readable storage device having stored thereon instructions that when executed by one or more processors result in the following operations comprising:
tracking user subjective data during exercise via user speech; and
capturing the user speech, the user speech comprising the user subjective data.

16. The device of claim 15, wherein the user subjective data comprises one or more of a perceived effort numeric indicator, a perceived effort descriptor and a user feeling narrative.

17. The device of claim 15, wherein the instructions that when executed by one or more processors results in the following additional operations comprising correlating the captured user subjective data to an associated exercise regime.

18. The device of claim 15, wherein the instructions that when executed by one or more processors results in the following additional operations comprising converting the captured user speech to text.

19. The device of claim 15, wherein the instructions that when executed by one or more processors results in the following additional operations comprising displaying the user subjective data annotated to associated objective data.

20. The device of claim 15, wherein the instructions that when executed by one or more processors results in the following additional operations comprising capturing user objective data.

21. The device of claim 15, wherein the user speech further comprises end of activity user subjective data.
